(19) United States
(12) Patent Application Publication
(10) Pub. No.: US 2022/0073331 A1
(43) Pub. Date: Mar. 10, 2022

(54) SYSTEMS, DEVICES, AND METHODS FOR OPERATING A JACK

(71) Applicant: Jordan Lee VanBodegom, Barrie (CA)

(72) Inventor: Jordan Lee VanBodegom, Barrie (CA)

(21) Appl. No.: 17/013,960

(22) Filed: Sep. 8, 2020

(51) Int. Cl. B66F 13/00

(52) U.S. Cl. CPC B66F 13/00

(57) ABSTRACT

Systems, devices, and methods for operating a jack are described herein. A connector for a jack has an elongated member that extends along a longitudinal axis from a first end to a second end. The elongated member has a driver connection portion at the first end to engage with a driver and a jack connection portion at the second end to engage with the jack. The driver and jack connection portions can each be openings that extend along the longitudinal axis from the first end to the second end to form a channel. The elongated member has a first pair of openings in a wall of the elongated member, the first pair of openings each along a first transverse axis and dimensioned to receive a first projection for securing the connector to the jack. In some embodiments, the elongated member has a second pair of openings in the wall.

### FIELD

The present disclosure generally relates to the field of jacks, and, in particular, to systems, devices, and methods for operating jacks.

### INTRODUCTION

A trailer jack can be used for raising or lowering a trailer by operating a hand crank attached to the trailer jack. The hand crank typically requires significant manual effort and difficulty to use when raising or lowering a trailer.

### SUMMARY

In accordance with an aspect, there is provided a connector for a jack. The connector has an elongated member extending along a longitudinal axis and a first end and a second end. The elongated member has a driver connection portion at the first end, the driver connection portion dimensioned to engage with a driver. The elongated member has a jack connection portion at the second end, the jack connection portion dimensioned to engage with the jack. The elongated member has a first pair of openings in a wall of the elongated member, the first pair of openings each along a first transverse axis and dimensioned to receive a first projection for securing the connector to the jack.

In some embodiments, the driver connection portion is a first opening, the first opening is dimensioned to receive the driver, and the jack connection portion is a second opening, the second opening dimensioned to receive the jack.

In some embodiments, the elongated member has a second pair of openings in a wall of the elongated member, the second pair of openings each along a second transverse axis.

In some embodiments, the first opening and the second opening extend along the longitudinal axis and form a single contiguous channel from the first end to the second end.

In some embodiments, the first opening and the second opening each have a square cross-sectional shape along a third transverse axis.

In some embodiments, the single contiguous channel has a square cross-sectional shape along a third transverse axis.

In some embodiments, the second pair of openings are dimensioned to receive a second projection.

In some embodiments, the first pair of openings are positioned at about 0.25 inches from the first end.

In some embodiments, the second pair of openings are positioned at about ⅜ inches from the second end.

In some embodiments, the first projection and the second projection are each a 0.25 inch bolt or pin.

In some embodiments, the first pair of openings and the second pair of openings each measure about 0.25 inches.

In some embodiments, the first opening and the second opening each measure about 0.5 inches.

In accordance with a further aspect, there is provided a jack assembly having the connector, the connector drivingly connected to an elongated jack member at the second opening; and a projection inserted through the first pair of openings or the second pair of openings, as well as through the elongated jack member.

In some embodiments, the projection is inserted through the elongated jack member at a jack opening, the jack opening aligned with the first pair of openings or the second pair of openings.

In some embodiments, the jack assembly further includes a driver having a hex shank measuring about 0.25 inches and having a socket adaptor measuring about 0.5 inches.

In accordance with a further aspect, there is provided a method for operating a jack including securing an elongated jack member with an elongated connector member; and rotatingly driving the elongated jack member by rotatingly driving the elongated connector member with a driver.

Other aspects and features and combinations thereof concerning embodiments described herein will be become apparent to those ordinarily skilled in the art upon review of the instant disclosure of embodiments in conjunction with the accompanying figures.

### DESCRIPTION OF THE DRAWINGS

In the figures, embodiments are illustrated by way of example. It is to be expressly understood that the description and figures are only for the purpose of illustration and as an aid to understanding. Embodiments will now be described, by way of example only, with reference to the attached figures, wherein in the figures:

FIG. 1 is a side perspective view of a connector for a jack, according to some embodiments;

FIG. 2 is a flat pattern view of a connector, according to some embodiments;

FIG. 3 is a cross-sectional view of a connector, according to some embodiments;

FIG. 4 is a flat pattern view of a top cross-sectional view of a connector, according to some embodiments; and

FIG. 5 is a schematic diagram of a side view of an example jack that can be used with a connector, according to some embodiments.

### DETAILED DESCRIPTION

Embodiments described herein provide a device that can be operably attached to a jack to provide a torque to drive the jack to raise or lower a heavy object such as a trailer. The device is secured to the jack using a projection such as a bolt or pin that is inserted through a pair of openings in the wall of the device and one or more corresponding openings in the wall of the jack, where the openings are aligned when the device is connected to the jack. The device can have another pair of openings in its wall at a different position from the end of the device such that the same device can be secured and used with a different jack that has one or more corresponding openings at correspondingly different positions from the end of the jack. An impact driver can be used to apply a torque to the device, which can, in turn, apply a torque to the jack to operate the jack. The device can be secured on the jack indefinitely so as to allow for easy and quick operation of the jack with minimal manual effort or strength from a user, in some embodiments. The device can eliminate a need to use a handle or hand crank to operate the jack and can allow for easy operation without the need for additional attachments or parts apart from the impact driver, in some embodiments.

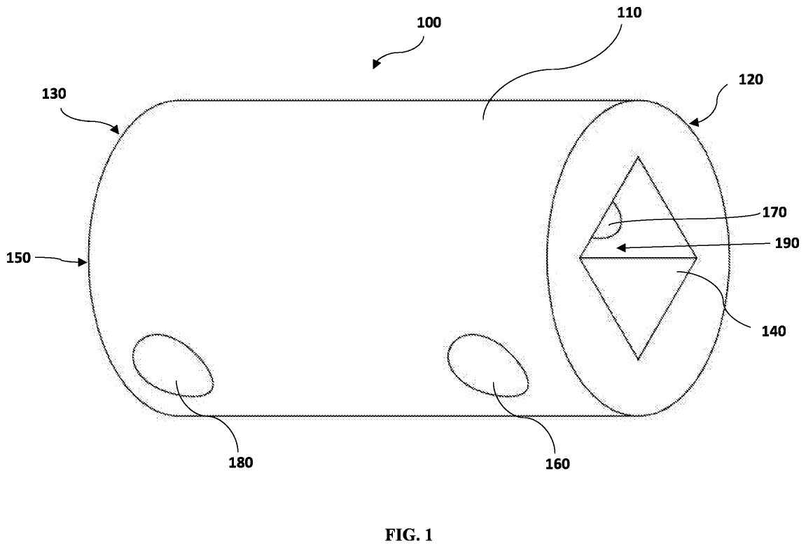

FIG. 1 is a side perspective view of an example connector 100 for a jack, according to some embodiments. As shown, the connector 100 has an elongated member 110 extending along a longitudinal axis and the elongated member has a first end 120 and a second end 130. The first end 120 and the second end 130 can be interchangeable depending on the jack, for example. The elongated member has a driver connection portion 140 at the first end 120 that is dimensioned to engage with a driver. In some embodiments, the driver connection portion 140 is a first opening 140 that is dimensioned to receive a driver. The first opening 140 can extend a distance in the longitudinal direction towards the second end 130 that allows the driver to sufficiently engage with the connector 100 so as to rotatingly drive the connector 100 in operation, such as by applying a torque. The elongated member 110 has a jack connection portion 150 at the second end 130 that is dimensioned to engage with a jack. In some embodiments, the jack connection portion 150 is a second opening 150 that is dimensioned to receive a jack. The second opening 150 can extend a distance in the longitudinal direction towards the first end 120 that allows the jack to sufficiently engage with the connector 100 so as to be rotatingly driven by or through the connector 100 in operation, such as by receiving a torque from the driver or connector 100. In some embodiments, the first opening 140 and the second opening 150 do not extend or meet along the longitudinal axis and do not form a contiguous channel. In some embodiments, the first opening 140 and/or the second opening 150 have a circular or polygonal cross-sectional shape along a cross-section taken along an axis substantially orthogonal to the longitudinal axis. The size of the first opening 140 and/or the second opening 150 measured at its widest dimension along this cross-section can be about 0.5 inches, for example. Other dimensions are possible. In some embodiments, the first opening 140 and the second opening 150 do extend along the longitudinal axis to form a contiguous channel 190.

The elongated member 110 has a pair of openings 160, 170 in the wall of the elongated member 110 with each opening at substantially opposite sides of the wall of the elongated member 110, for example, each along a single axis that is substantially transverse (e.g., substantially orthogonal) to the longitudinal axis of the elongated member 110. In other words, an axis extending through the openings 160 and 170 can be substantially orthogonal to a longitudinal axis extending from a first end 120 to a second end 130 of the connector 110.

As shown, each opening 160 or 170 in the pair of openings 160, 170 is positioned relative to each other and in the elongated member 110 as well as sized and dimensioned such that a projection such as a bolt or pin can be inserted through both openings in a pair in order to secure the connector 100 to a jack. Various types or styles of projections can be used to fasten the connector 100 to a jack. This can enable the connector 100 to be secured to the jack, for example, when the jack is in use. The connector 100 remain secured to the jack when the jack is not in use such that a user can easily and simply operate the jack by applying a driver to the connector 100 without further assembly. The connector 100 can operate as a shaft or rotating member that transmits power or rotational motion. For example, the projection or bolt can be inserted first through an opening in the connector 100, then through an opening in the jack, and then through a second opening in the connector 100 (e.g., at an opposite wall in the connector 100).

The opening in the jack can be a channel that extends through the jack along an axis that is substantially orthogonal to a longitudinal axis extending from one end of the jack to the other. In some embodiments, various configurations of the opening in the jack can be provided. For example, there can be two aligned openings or a pair of openings in the outside walls of the jack (e.g., in an elongated jack member) if the jack has a channel extending along the longitudinal axis of the jack. In this case, to secure the connector to the jack, the projection or bolt can be inserted first through an opening in the connector 100, then through an opening in the jack, then through a second opening in the jack (e.g., at an opposite wall in the jack), and then through a second opening in the connector 100 (e.g., at an opposite wall in the connector 100).

The portion of the jack that connects to the jack connection portion 150 can be a shaft that would otherwise connect with a handle that can be used to turn up or down the jack or raise or lower a trailer attached to the jack. In some embodiments, connector 100 eliminates the need for the handle and provides an easier way to operate the jack, such as with less effort or manual force required by a user and without requiring attachment of a separate apparatus such as a handle or hand crank. It may otherwise require a lot of strength and effort to lift or drop a trailer using a hand crank. The connector 100 can be attached to the jack indefinitely without a need to remove the connector 100 between uses. An impact driver can easily be applied to the connector 100 whenever it is desired to operate the jack.

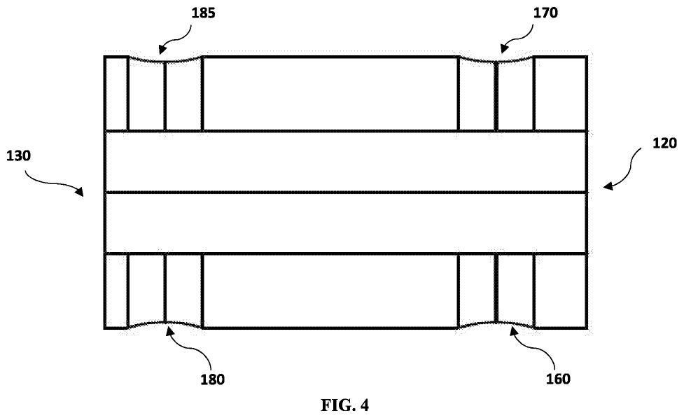

In some embodiments, the elongated member 110 has a second pair of openings (e.g., at opening 180 and at an opening opposite to opening 180) in the wall of the elongated member 110 with each opening at substantially opposite sides of the wall of the elongated member 110. An axis extending through the openings making up the second pair of openings can be substantially orthogonal to a longitudinal axis extending from a first end 120 to a second end 130 of the connector 110. In some embodiments, elongated member 110 has one or more additional pairs of openings or recesses in the wall of the elongated member 110 that can be used to secure additional attachments (e.g., other jack configurations). In some embodiments, the connector 100 has two pairs of openings (e.g., including openings 160, 170, 180, and, with reference to FIG. 4, 185), with each pair positioned at a different distance from the end of the connector 100. In some embodiments, this configuration can allow for easier configuration and increased versatility of the connection 100 as the same connector 100 can engage with jacks having different engagement configurations. For example, different jacks can have different hole locations for receiving a projection such as a bolt for securing the jack to the connector 100. A connector 100 having different pairs of openings positioned at different distances from an end 120 or 130 can allow these different jacks to be secured to the same connector 100 at the appropriate pair of openings. For example, on engagement of the connector 100 with a jack, a pair of openings of the connector 100 is aligned with a corresponding hole or opening or engagement portion of the jack. A projection such as a bolt or pin can be inserted simultaneously through the opening in the jack and each of the openings in that pair of openings in the connector 100. A different jack having hole(s) or opening(s) or engagement portion(s) at a different position in the jack (e.g., at a different distance from the end of an elongated member at the top of the jack) can later engage with the same connector 100 such that a different pair of openings of the connector 100 (e.g., a pair of openings positioned at a different distance from an end 120 or 130 of the jack) are aligned with the hole(s) or opening(s) or engagement portion(s) of that jack.

The portion of the jack that connects to the jack connection portion 150 can be an elongated member such as a shaft that would otherwise connect with a handle that can be used to turn up or down the jack or raise or lower a trailer attached to the jack. In some embodiments, connector 100 eliminates the need for the handle and provides an easier way to operate the jack, such as with less effort or manual force required by a user and without requiring attachment of a separate apparatus such as a handle.

In some embodiments, the driver connection portion 140 engages with a driver by insertion into a portion of the driver such as at an opening (e.g., cavity, recess, or channel) of the driver. In some embodiments, the jack connection portion 150 engages with a jack by insertion into a portion of the jack such as at an opening (e.g., cavity, recess, or channel) of the jack. The connector 100 can be secured to the jack by inserting a projection such as a bolt or pin through aligned openings in jack and the connector, for example, first through an opening in the jack, then through an opening in the connector, then through a second opening in the connector (e.g., at an opposite wall in the elongated member 110), and then through a second opening in the jack (e.g., at an opposite wall in the jack). As another example, the projection can be inserted first through an opening in the jack, then through an opening extending through the connector, and then through a second opening in the jack (e.g., at an opposite wall in the jack).

In some embodiments, the driver is an impact driver with a shank connected to a socket adaptor that can be inserted into the first opening 140. Once the driver engages with the driver connection portion 140, the driver is operable to drive the connector 100. For example, in some embodiments, the driver operably connects to the connector 100 by insertion into the first opening 140 and applies a rotational or torque force to the connector 100. The connector 100 is operable to transfer torque force to a jack with which it is engaged. For example, in some embodiments, a jack (such as at an elongated member extending from the top end of the jack) is inserted into a second opening 150 of the elongated member 110 of the connector 100 and secured in place (e.g., by insertion of a bolt through the jack and connector) and, in operation, the connector 100 drives the jack by applying a rotational force or torque to the elongated member of the jack. The elongated member of the jack can, in turn, drive mechanical components of the jack to extend or retract a leg of the jack so as to raise, lower, lift, or drop a trailer. Prior to operation, the jack can be attached and secured to the front end of a trailer to lift or drop the trailer.

In some embodiments, connector 100 has a contiguous channel 190 extending from a first end 120 to a second end 150. The channel 190 is defined by interior walls of the connector 100. The opening 140 at the first end 120 and opening 150 at the second end 150 can be connected by the channel 190 or extend along the longitudinal axis of the elongated member 110 to form the channel 190. The channel 190 is dimensioned to receive a driver at the first end 120 and allow a force such as a torque to be applied by the driver to the connector 100 and allow the connector 100 to transfer or otherwise apply a force such as a torque to a jack engaged at the second end 150. The channel 190 is dimensioned to receive the jack (e.g., an elongated jack member of the jack) at the second end 130 and allow a force such as a torque to be applied by the connector 100 or driver to the jack to operate the jack. The jack can then be operated to raise or lift a heavy object such as a trailer that the jack is secured to.

In some embodiments, the channel 190 has a substantially square cross-sectional shape along a cross-section taken along an axis substantially orthogonal to the longitudinal axis. The cross-sectional shape of the channel 190 can be sized and dimensioned to accommodate a portion of a driver that engages at the first end 120 as well as to accommodate a portion of the jack that engages at the second end 150. In some embodiments, the cross-sectional shape of the channel 190 is different at the first end 120 as compared to the second end 150. In some embodiments, the channel 190 has a different cross-sectional shape (e.g., a circular or polygonal) along a cross-section taken along an axis substantially orthogonal to the longitudinal axis. The size of the opening defined by the cross-sectional shape can be about 0.5 inches measured at its widest dimension, for example. Other sizes can be used in different embodiments.

In some embodiments, there is provided a round elongated metal piece 100 with a square hole cut through the entire body from a top end 120 to a bottom end 130. There are two holes in the elongated piece 100 that fit a bolt that can be inserted through the hole of the jack. The hole of the jack is the hole that a bolt would have been inserted into to fasten a handle that could be used to operate the jack. To accommodate different makes of available jacks on the market that have two different hole locations, the elongated piece 100 also has two different hole locations. These holes in the elongated piece 100 are drilled such that one hole is placed at a distance from one side of the elongated piece 100 and the other hole is placed at another distance from the opposite side of the elongated piece 100.

Different jacks have the same shaft size and same hole size to receive the bolt, and the elongated piece 100 and its components can be sized, dimensioned, and positioned to accommodate same. Example dimensions include the following. A 1 1/16 inch round elongated metal piece can be provided that is 2 inches long with a ½ inch square hole cut through the entire body from a top end 120 to a bottom end 130. The two holes that fit the bolt can fit a ¼ inch bolt. One hole is drilled at ¼ inches from one side of the elongated piece 100 and the other hole is placed at ⅜ inches from the opposite side of the elongated piece 100. Trailer jacks can have a ½ inch shaft size and a hole sized to receive a ¼ inch bolt. Each hole in the elongated piece 100 and jack can correspond to a pair of openings, with each opening in the pair on substantially opposite walls of the respective device, for example, as formed by drilling through the walls of the respective device along an axis substantially perpendicular to an axis extending from a first end to the second end of the respective device.

The torque needed to lift a trailer or other heavy object that the jack is operable to lift is supplied by an impact driver with a ¼ inch hex shank connected to a ½ inch socket adaptor. The socket adaptor can, in turn, connect to the elongated piece 100 to rotationally drive the jack.

In various embodiments, various sizes, dimensions, and positions of various components described herein are possible, such as different impact driver shank sizes, impact driver socket adaptors, channel or hole sizes of the connector 100, opening or hole sizes of the connector 100 for securing the connector 100, shank sizes of the jack, and projection or bolt dimensions for securing the connector 100 or jack.

The connector 100 can be in a variety of different shapes. For example, the cross-sectional shape along a cross-section taken along an axis substantially orthogonal to the longitudinal axis can be substantially round or substantially polygonal (e.g., square).

The connector 100 or any portion can be made from metal or other material. The material or its processing can allow the connector 100 or its respective portions to receive a force applied by a driver and, in turn, apply a force to a jack to drive the operation of the jack and move, raise, or lower a trailer attached to the jack. For example, the driver can apply a torque to the connector 100 and the connector 100 can rotate around its longitudinal axis in rapid succession and apply a corresponding torque or rotational force to a shaft of the jack.

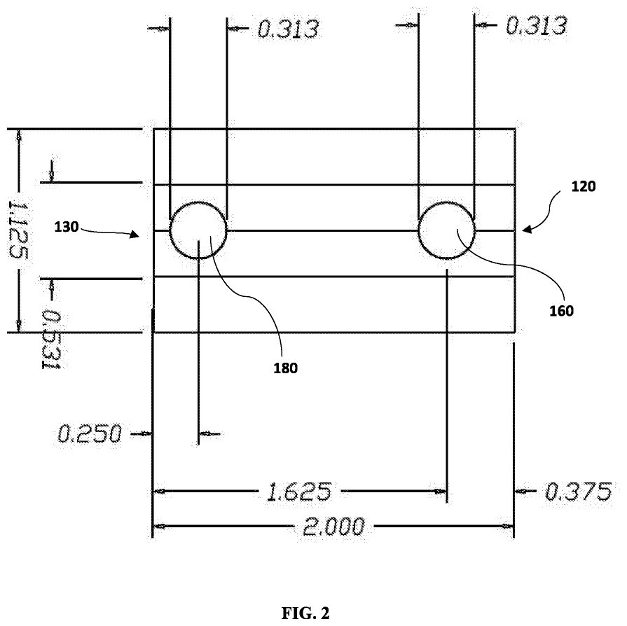

FIG. 2 is a flat pattern view of an example connector 100, according to some embodiments. As shown, opening 160 and opening 180 can each be circular and have a diameter of about 0.313 inches. Corresponding openings on opposite sides of the wall of connector 100 can be correspondingly sized and shaped. The length of the connector 100 from a first end 120 to a second end 130 can be about 2.000 inches and the length of the connector 100 from the second end 130 to the centre of the opening 160 can be about 1.625 inches. The distance from the second end 130 to the centre of the opening 180 can be about 0.250 inches. The distance from the first end 120 to the centre of the opening 160 can be about 0.375 inches. The length of the perimeter of a cross-section of the channel 190, the cross-section taken along an axis substantially orthogonal to a longitudinal axis extending from the first end 120 to the second end 130, can be about 1.125 inches. The channel 190 can have a square cross-section as shown, with each side of the square being about 0.510 inches long. The channel 190 can be defined by the interior walls of the connector 100 and be about 2.000 inches by about 0.510 inches by about 0.510 inches.

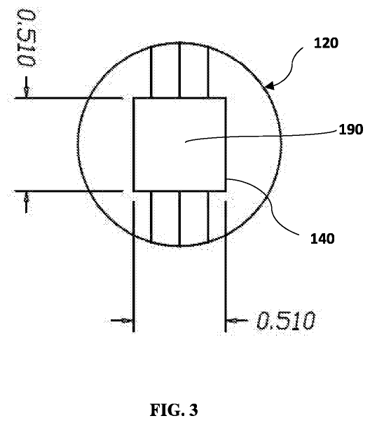

FIG. 3 is a cross-sectional view of an example connector 100, according to some embodiments. The cross-section is taken along an axis substantially orthogonal to a longitudinal axis that extends from a first end 120 to a second end 130 of the connector 100. As shown, channel 190 has a square cross-section and extends from a first end 120 at first opening 140 and ends at the second opening 150 at the second end 130. The square cross-section can be about 0.510 by about 0.510 inches, for example. The channel 190 can be defined by the interior walls of the connector 100 and be about 2.000 inches by about 0.510 inches by about 0.510 inches.

FIG. 4 is a flat pattern view of a top cross-sectional view of an example connector 100, according to some embodiments. The cross-section is taken along a longitudinal axis that extends from a first end 120 to a second end 130 of the connector 100. A half pattern view of each of the openings 160, 170, 180, and 185 are shown. Openings 160 and 170 together form the first opening pair 160, 170 and opening 180 and 185 together form the second opening pair 180, 185. The connector 100 is dimensioned and its openings 160, 170, 180, and 185 are positioned and aligned so as to enable a projection such as a bolt or pin to be fastened or secured through one of the opening pairs 160, 170 or 180, 185 and through corresponding openings in a jack that are aligned with that one of the openings pairs 160, 170 or 180, 185. In some embodiments, this can allow the connector 100 to be used with and secured to different jacks, as different jacks can have their corresponding openings positioned at different distances from the top of the jack.

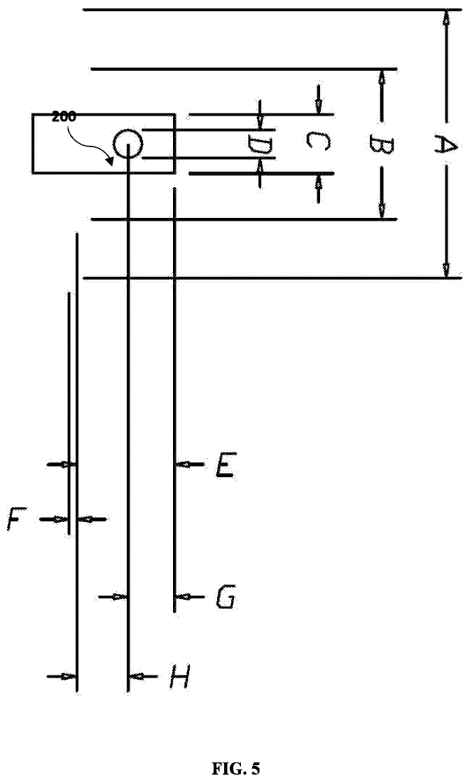

FIG. 5 is a schematic diagram of a side view of an example jack that can be used with an example connector 100, according to some embodiments. As shown, the jack has an opening 200 for insertion of a projection such as a bolt or pin that can be used to fasten the jack to the connector 100 through a pair of openings 160, 170 or pair of openings 180, 185, for example. In various embodiments, the dimensions and positioning of connector 100 and its various component parts including the size and positioning of openings 160, 170, 180, and 185 and the circumference or perimeter of the elongated member 110 measured along its outside wall can be configured to correspond with the various dimensions of various portions of the jack to allow the connector 100 to drive the jack such as by applying a rotational force or torque to the jack to operate the jack and raise or lower an attached or adjoining trailer. In particular, jacks having dimensions as shown in Table 1 corresponding to the letters show in in FIG. 5 can all be operable with the same connector 100 or with different embodiments of connector 100. The dimensions and configurations of the jack can also correspondingly influence the driver design. For example, a connector 100 can have a pair of openings with each opening sized to receive a projection that fits through the opening 200 having the dimension D. As another example, the connector 100 can have a pair of openings 180, 185 at a distance from the second end 130 of the connector 100 that allows the pair of openings 180, 185 to be aligned with the opening 200 of the jack if the jack is inserted into the connector 100 at the second end 130. Dimensions denoted by A, B, and F can illustrate dimensions of a jack, such as the width and height of the jack or portion thereof.

TABLE 1
Example Dimensions of Jacks Potentially Usable
with the Some Embodiments of the Connector.

| | | | | | | | Used with |
|---|---|---|---|---|---|---|---|
| | | | | | | | Embodiment of |
| | Capacity | Dimensions (inches) | | | | | Connector? |
| Manufacturer | (lb.) | C | D | E | G | H | C |
| Power Fist | 2000 | ½ | 0.25 | 0.8125 | 0.40625 | 0.40625 | Yes |
| Power Fist | 2250 | 0.49 | 0.255 | 0.9375 | 0.500 | 0.853 | Yes |
| Power Fist | 5000 | ½ | 0.25 | 0.67 | 0.365 | 0.305 | Yes |
| Power Fist | 7000 | 0.728 | 0.315 | 0.935 | 0.3125 | 0.622 | No |
| Bull Dog | 2000 | 0.5 | 0.25 | 0.745 | 0.305 | 0.995 | Yes |
| Butler | 5000 | 0.5 | 0.236 | 1.125 | 0.397 | 0.728 | Yes |
| Reese | 1000 | 0.490 | 0.234 | 1.161 | 0.319 | 0.842 | Yes |

In some embodiments, there is provided a jack assembly having a connector 100 with the connector 100 drivingly connected to an elongated jack member at a second opening 150. A projection such as a bolt or pin is inserted through the first pair of openings 160, 170 or, alternatively, through the second pair of openings 180, 185, in addition to through the elongated jack member such as through an opening in the elongated jack member (e.g., a jack opening). The elongated jack member can be a shaft of the jack, where the shaft operates to facilitate the raising or lowering of a heavy object secured to the jack such as a trailer. The shaft can receive a rotational force and operate by rotating and causing a portion of the jack to extend or retract or itself extending or retracting in order to raise or lower the heavy object.

In some embodiments, the projection is inserted through the elongated jack member in an opening in the wall of the elongated jack member, the opening extending along an axis that is substantially orthogonal to a longitudinal axis extending from one end of the elongated jack member to the other end of the elongated jack member. The opening in the wall of the elongated jack member can be aligned with one of the pairs of openings 160, 170 or 180, 185 when the jack is engaged with the connector 100 at the second end 130. The opening in the wall of the elongated jack member can be termed a jack opening. For example, the elongated jack member can be inserted into the channel 190 at opening 150 at the second end 130 and the opening in the elongated jack member can be aligned with one of the pairs of openings in the connector 100 and a projection such as a bolt or pin can be inserted through the three openings to secure the connector 100 to the jack. In operation, the jack (e.g., at an elongated jack member) can be secured to one end of the connector (e.g., at an elongated connector member 110) using a bolt and the elongated jack member can be driven by rotation of the connector (e.g., at the elongated connector member) when the elongated connector member 110 is driven by rotation of a driver at the other end of the connector. The elongated jack member and the elongated connector member 110 can each be a shaft.

In some embodiments, a method for manufacturing a connector 100 is provided. The connector 100 can be formed using a mold and a pair of openings 160, 170 and/or pair of openings 180, 185 can each be formed by drilling through the connector 100 at an angle that is substantially orthogonal to a longitudinal axis extending from the ends of the connector 100. For example, the angle can be about 90 degrees. Various metals or other materials or combination of same can be used to form connector 100 and/or projection(s) that are used to secure the connector 100 to a jack. The materials can be selected for facilitating compatibility between the connector 100 and projection and/or for cost of manufacturing.

The discussion herein provides example embodiments of the technology. The technology is considered to include all possible combinations of the disclosed elements. Accordingly, if one embodiment comprises elements A, B, and C and a second embodiment comprises elements B and D, then embodiments of the technology are contemplated to also comprise elements A, B, C, and D, as well as other remaining combinations of A, B, C, or D, even if not explicitly disclosed.

Although various embodiments have been described in detail, it should be understood that various changes, substitutions, and alterations can be made herein. Moreover, the scope of the present application is not intended to be limited to the particular embodiments of the process, machine, manufacture, composition of matter, means, methods and steps described in the specification.

As can be understood, the examples described herein and illustrated are intended to be exemplary only.

What is claimed is:

1. A connector for a jack, comprising:
an elongated member extending along a longitudinal axis and having a first end and a second end, the elongated member having a driver connection portion at the first end, the driver connection portion dimensioned to engage with a driver, the elongated member having a jack connection portion at the second end, the jack connection portion dimensioned to engage with the jack, the elongated member having a first pair of openings in a wall of the elongated member, the first pair of openings each along a first transverse axis and dimensioned to receive a first projection for securing the connector to the jack.

2. The connector of claim 1, the driver connection portion being a first opening, the first opening dimensioned to receive the driver, and the jack connection portion being a second opening, the second opening dimensioned to receive the jack.

3. The connector of claim 1, the elongated member having a second pair of openings in a wall of the elongated member, the second pair of openings each along a second transverse axis.

4. The connector of claim 2, the first opening and the second opening extending along the longitudinal axis and forming a single contiguous channel from the first end to the second end.

5. The connector of claim 2, the first opening and the second opening each having a square cross-sectional shape along a third transverse axis.

6. The connector of claim 4, the single contiguous channel having a square cross-sectional shape along a third transverse axis.

7. The connector of claim 1, the second pair of openings dimensioned to receive a second projection.

8. The connector of claim 1, the first pair of openings positioned at about 0.25 inches from the first end along the longitudinal axis.

9. The connector of claim 1, the second pair of openings positioned at about ⅜ inches from the second end along the longitudinal axis.

10. The connector of claim 7, the first projection and the second projection each being a 0.25 inch bolt or pin.

11. The connector of claim 3, the first pair of openings and the second pair of openings each measuring about 0.25 inches.

12. The connector of claim 2, the first opening and the second opening each measuring about 0.5 inches.

13. A jack assembly, comprising:
the connector of claim 2, the connector drivingly connected to an elongated jack member at the second opening; and
a projection inserted through the first pair of openings, as well as through the elongated jack member.

14. The jack assembly of claim 13, the projection inserted through the elongated jack member at a jack opening, the jack opening aligned with the first pair of openings or the second pair of openings.

15. The jack assembly of claim 14, further comprising a driver having a hex shank measuring about 0.25 inches and having a socket adaptor measuring about 0.5 inches.

16. A method for operating a jack, comprising:
securing an elongated jack member with an elongated connector member; and
rotatingly driving the elongated jack member by rotatingly driving the elongated connector member with a driver.
